(19) United States
(12) Patent Application Publication
(10) Pub. No.: US 2021/0206933 A1
(43) Pub. Date: Jul. 8, 2021

(54) HARD COATING FILM AND IMAGE DISPLAY DEVICE COMPRISING SAME

(71) Applicant: DONGWOO FINE-CHEM CO., LTD., Jeollabuk-do 54631 (KR)

(72) Inventors: Geo San Lim, Seoul (KR); Min Kyung Kang, Gyeonggi-do (KR); Seung Hee Kim, Gyeonggi-do (KR)

(21) Appl. No.: 17/059,254

(22) PCT Filed: May 27, 2019
(86) PCT No.: PCT/KR2019/006343

§ 371 Date: Nov. 27, 2020

(30) Foreign Application Priority Data
Jun. 4, 2018 (KR) 10-2018-0064338

(51) Int. Cl. C08J 7/046; C08J 7/044; C08K 5/07; G02B 1/14; C08K 5/00; C09D 201/00; C09D 7/63

(52) U.S. Cl. CPC C08J 7/046; C08J 7/044; C08K 5/07; G02B 1/14; C08J 2400/00; C09D 201/00; C09D 7/63; C08J 2379/08; C08K 5/0075

(57) ABSTRACT

A hard coating film may be configured such that a hard coating layer including a cured product of a hard coating composition is formed on at least one surface of a substrate, in which the hard coating composition includes an ionic antistatic agent and a photopolymerization initiator containing a hydroxyethoxy group, the surface resistance of the hard coating layer is 1E+9 to 1E+12 Ω/□, and the total transmittance thereof is 89.0% or more, thus exhibiting superior antistatic performance, superior optical performance such as high transmittance and the like, improved durability such as scratch resistance and the like, and superior bending resistance, making it applicable to a flexible image display device and to a window and an image display device including the same.

### CROSS-REFERENCE TO RELATED APPLICATIONS

This application is a national phase entry under 35 U. S.C. § 371 of International Patent Application PCT/KR2019/006343, filed May 27, 2019, designating the United States of America and published in Korean as International Patent Publication WO 2019/235770 A1, which claims priority to the Korean Patent Application KR 10-2018-0064338, filed on Jun. 4, 2018, each of which is incorporated herein by this reference in its entirety.

### TECHNICAL FIELD

The present invention relates to a hard coating film and an image display device including the same.

### BACKGROUND

A flexible display is a display that is bendable or foldable, and various technologies and patents related thereto have been proposed. When the display is designed to have a foldable form, it may be used as a tablet when unfolded and a smartphone when folded, so displays having different sizes may be used in a single product. In addition, in the case of larger-sized devices such as tablets and TVs, rather than small-sized smartphones, convenience may be doubled if they may be folded and carried.

In a general display, a cover window made of glass is provided on the outermost side to protect the display. However, glass cannot be applied to flexible displays, and a hard coating film having superior durability is used in place of glass.

Recently, with an increased demand for touch-type displays, the possibility of contacting the display device directly using the hand or the like is increasing. In this way, when a direct contact with the outermost side of the display device using the hand or the like is attempted, static electricity may be generated, causing inconvenience to the user. Moreover, there is a problem in that abnormalities may be caused in the device due to the static electricity thus generated, and it is necessary to develop a hard coating film imparted with an antistatic function in order to minimize the generation of such static electricity.

In this regard, Korean Patent Application Publication No. 2003-0025914 discloses an antistatic hard coating composition prepared by mixing (A) 100 parts by weight of multifunctional acrylate, (B) 50 to 400 parts by weight of conductive fine particles having a particle size of 10 to 30 nm, and (C) 10 to 80 parts by weight of at least one silicone compound selected from the group consisting of silica particles surface-treated with organic material, organopolysiloxane, and silicone acrylate. However, this composition exhibits poor bending resistance, and thus cannot be applied to recently developed flexible image display devices.

In addition, Korean Patent No. 10-1025668 discloses a conductive polymer composition having a solid content of 0.1 to 10 wt %, including 100 parts by weight of solid content of a water-dispersible polyurethane resin; 0.05 to 0.5 parts by weight of a conductive polymer based on the solid content; 10 to 60 parts by weight of methoxymethyl melamine; 0.2 to 5.0 parts by weight of an organic acid based on 100 parts by weight of the methoxymethyl melamine; and a diluent. This composition is problematic because of poor mechanical strength and thus high incidence of scratches, as well as poor durability, such as high likelihood of damage to products.

### SUMMARY

### Technical Problem

The present invention has been made keeping in mind the problems encountered in the related art, and an objective of the present invention is to provide a hard coating film, which may exhibit not only superior optical performance and antistatic performance but also high durability such as scratch resistance, etc. and superior bending resistance and may thus be applied to a flexible image display device, and a window and an image display device including the same.

### Technical Solution

The present invention provides a hard coating film configured such that a hard coating layer including a cured product of a hard coating composition is formed on at least one surface of a substrate, in which the hard coating composition includes an ionic antistatic agent and a photopolymerization initiator containing a hydroxyethoxy group, the surface resistance of the hard coating layer is 1E+9 to 1E+12 Ω/□, and the total transmittance thereof is 89.0% or more.

In addition, the present invention provides a window including the hard coating film described above.

In addition, the present invention provides an image display device including the window described above.

### Advantageous Effects

According to the present invention, a hard coating film is capable of exhibiting improved optical performance such as high transmittance and the like and lowering surface resistance, thereby increasing antistatic performance, and can exhibit high durability such as scratch resistance, etc., and also superior bending resistance, and can thus be applied to flexible image display devices.

According to the present invention, a window includes the hard coating film, and thus has the same advantages as described above.

According to the present invention, an image display device includes the window, and thus has the same advantages as described above.

### Mode for Invention

When a member is said to be located “on” another member in the present invention, it can be directly on the other member, or intervening members may be present therebetween.

When a portion is said to “comprise” or “include” an element in the present invention, this means that other elements may be further included, rather than excluding such other elements, unless otherwise specified.

Hereinafter, a detailed description will be given of the present invention.

### DETAILED DESCRIPTION

<Hard Coating Film>

An aspect of the present invention pertains to a hard coating film, configured such that a hard coating layer including a cured product of a hard coating composition is formed on at least one surface of a substrate, in which the hard coating composition includes an ionic antistatic agent and a photopolymerization initiator containing a hydroxyethoxy group, the surface resistance of the hard coating layer is 1E+9 to 1E+12 Ω/□, and the total transmittance thereof is 89.0% or more. Thereby, the hard coating film may exhibit superior antistatic performance, superior optical performance such as high transmittance, etc., high durability such as scratch resistance, etc., and superior bending resistance, and is thus applicable to flexible image display devices.

Here, the transmittance is a value measured using an integrating sphere spectrophotometer CM-3600D for the hard coating film.

Substrate

The hard coating film according to an aspect of the present invention includes a substrate.

The substrate may be used without particular limitation, so long as it is a substrate used in the art, and specifically, a film having superior transparency, mechanical strength, thermal stability, moisture resistance, isotropy, etc. may be used. More specifically, the substrate may be a film including at least one selected from among thermoplastic resins, including a polyester-based resin such as polyethylene terephthalate, polyethylene isophthalate, polyethylene naphthalate, polybutylene terephthalate and the like; a cellulose-based resin such as diacetyl cellulose, triacetyl cellulose and the like; a polycarbonate-based resin; an acrylic resin such as polymethyl (meth)acrylate, polyethyl (meth)acrylate and the like; a styrene-based resin such as polystyrene, an acrylonitrile-styrene copolymer and the like; a polyolefin-based resin such as polyethylene, polypropylene, polyolefin having a cyclic or norbornene structure, an ethylene-propylene copolymer and the like; a vinyl-chloride-based resin; an amide-based resin such as nylon, an aromatic polyamide and the like; an imide-based resin; a sulfone-based resin; a polyethersulfone-based resin; a polyetheretherketone-based resin; a polyphenylene-sulfide-based resin; a vinyl-alcohol-based resin; a vinylidene-chloride-based resin; a vinyl-butyral-based resin; an allylate-based resin; a polyoxymethylene-based resin; an epoxy-based resin, and the like, and a film including a blend of thermoplastic resins may be used. Also, a film including a (meth)acryl-, urethane-, acrylurethane-, epoxy-, or silicone-based thermosetting resin or UV-curable resin may be used. In an embodiment of the present invention, the substrate may include a polyimide-based resin, which has superior resistance to repeated bending and may thus be more easily applied to a flexible image display device.

Hard Coating Layer

The hard coating film according to an aspect of the present invention includes a hard coating layer including a cured product of a hard coating composition formed on at least one surface of the substrate.

Hard Coating Composition

The hard coating composition includes an ionic antistatic agent and a photopolymerization initiator containing a hydroxyethoxy group, whereby the surface resistance of the hard coating layer including the same is adjusted within the range required by the present invention, thus increasing antistatic performance and exhibiting high transmittance and superior scratch resistance and bending resistance.

Ionic Antistatic Agent

As the ionic antistatic agent of the present invention, any one that is used in the art may be used without particular limitation, so long as it is able to impart ionic conductivity to the hard coating layer.

Specifically, the ionic antistatic agent may include an ionic liquid, a lithium salt, a quaternary ammonium salt, and the like, but is not limited thereto.

The ionic liquid may be a molten salt (ionic compound) in a liquid phase at room temperature. The cation of the ionic liquid may include a pyridinium cation, a piperidinium cation, a pyrrolidinium cation, a cation having a pyrroline skeleton, a cation having a pyrrole skeleton, an imidazolium cation, a tetrahydropyrimidinium cation, a dihydropyrimidinium cation, a pyrazolium cation, a pyrazolinium cation, a tetraalkylammonium cation, a trialkylsulfonium cation, a tetraalkylphosphonium cation, and the like. Examples thereof may include, but are not limited to, a 1-ethylpyridinium cation, a 1-butylpyridinium cation, a 1-hexylpyridinium cation, a 1-butyl-3-methylpyridinium cation, a 1-butyl-4-methylpyridinium cation, a 1-hexyl-3-methylpyridinium cation, a 1-butyl-3,4-dimethylpyridinium cation, a 1,1-dimethylpyrrolidinium cation, a 1-ethyl-1-methylpyrrolidinium cation, a 1-methyl-1-propylpyrrolidinium cation, a 2-methyl-1-pyrroline cation, a 1-ethyl-2-phenylindole cation, a 1,2-dimethylindole cation, a 1-ethylcarbazole cation, a 1,3-dimethylimidazolium cation, a 1,3-diethylimidazolium cation, a 1-ethyl-3-methylimidazolium cation, a 1-butyl-3-methylimidazolium cation, a 1-hexyl-3-methylimidazolium cation, a 1-octyl-3-methylimidazolium cation, a 1-decyl-3-methylimidazolium cation, a 1-dodecyl-3-methylimidazolium cation, a 1-tetradecyl-3-methylimidazolium cation, a 1,2-dimethyl-3-propylimidazolium cation, a 1-ethyl-2,3-dimethylimidazolium cation, a 1-butyl-2,3-dimethylimidazolium cation, a 1-hexyl-2,3-dimethylimidazolium cation, a 1,3-dimethyl-1,4,5,6-tetrahydropyrimidinium cation, a 1,2,3-trimethyl-1,4,5,6-tetrahydropyrimidinium cation, a 1,2,3,4-tetramethyl-1,4,5,6-tetrahydropyrimidinium cation, a 1,2,3,5-tetramethyl-1,4,5,6-tetrahydropyrimidinium cation, a 1,3-dimethyl-1,4-dihydropyrimidinium cation, a 1,3-dimethyl-1,6-dihydropyrimidinium cation, a 1,2,3-trimethyl-1,4-dihydropyrimidinium cation, a 1,2,3-trimethyl-1,6-dihydropyrimidinium cation, a 1,2,3,4-tetramethyl-1,4-dihydropyrimidinium cation, a 1,2,3,4-tetramethyl-1,6-dihydropyrimidinium cation, a 1-methylpyrazolium cation, a 3-methylpyrazolium cation, a 1-ethyl-2-methylpyrazolinium cation, a tetramethylammonium cation, a tetraethylammonium cation, a tetrapropylammonium cation, a tetrabutylammonium cation, a tetrapentylammonium cation, a tetrahexylammonium cation, a tetraheptylammonium cation, a triethylmethylammonium cation, a tributylethylammonium cation, a trimethyldecylammonium cation, a trioctylmethylammonium cation, a tripentylbutylammonium cation, a trihexylmethylammonium cation, a trihexylpentylammonium cation, a triheptylmethylammonium cation, a triheptylhexylammonium cation, an N,N-diethyl-N-methyl-N-(2-methoxyethyl)ammonium cation, a glycidyltrimethylammonium cation, a diallyldimethylammonium cation, an N,N-dimethyl-N,N-dipropylammonium cation, an N,N-dimethyl-N,N-dihexylammonium cation, an N,N-dipropyl-N,N-dihexylammonium cation, an N,N-dimethyl-N-ethyl-N-propylammonium cation, an N,N-dimethyl-N-ethyl-N-butylammonium cation, an N,N-dimethyl-N-ethyl-N-pentylammonium cation, an N,N-dimethyl-N-ethyl-N-hexylammonium cation, an N,N-dimethyl-N-ethyl-N-heptylammonium cation, an N,N-dimethyl-N-propyl-N-butylammonium cation, an N,N-dimethyl-N-propyl-N-pentylammonium cation, an

N,N-dimethyl-N-propyl-N-hexylammonium cation, an N,N-dimethyl-N-propyl-N-heptylammonium cation, an N,N-dimethyl-N-butyl-N-hexylammonium cation, an N,N-dimethyl-N-butyl-N-heptylammonium cation, an N,N-dimethyl-N-pentyl-N-hexylammonium cation, an N,N-dimethyl-N-hexyl-N-heptylammonium cation, a trimethylheptylammonium cation, an N,N-diethyl-N-methyl-N-propylammonium cation, an N,N-diethyl-N-methyl-N-pentylammonium cation, an N,N-diethyl-N-methyl-N-heptylammonium cation, an N,N-diethyl-N-propyl-N-pentylammonium cation, a triethylmethylammonium cation, a triethylpropylammonium cation, a triethylpentylammonium cation, a triethylheptylammonium cation, an N,N-dipropyl-N-methyl-N-ethylammonium cation, an N,N-dipropyl-N-methyl-N-pentylammonium cation, an N,N-dipropyl-N-butyl-N-hexylammonium cation, an N,N-dibutyl-N-methyl-N-pentylammonium cation, an N,N-dibutyl-N-methyl-N-hexylammonium cation, a trioctylmethylammonium cation, an N-methyl-N-ethyl-N-propyl-N-pentylammonium cation, a trimethylsulfonium cation, a triethylsulfonium cation, a tributylsulfonium cation, a trihexylsulfonium cation, a diethylmethylsulfonium cation, a dibutylethylsulfonium cation, a dimethyldecylsulfonium cation, a tetramethylphosphonium cation, a tetraethylphosphonium cation, a tetrabutylphosphonium cation, a tetrapentylphosphonium cation, a tetrahexylphosphonium cation, a tetraheptylphosphonium cation, a tetraoctylphosphonium cation, a triethylmethylphosphonium cation, a tributylethylphosphonium cation, a trimethyldecylphosphonium cation, and the like.

The anion of the ionic liquid is not particularly limited, so long as it enables the formation of an ionic liquid. Examples thereof may include, but are not limited to, Cl⁻, Br, F, AlCl₄₋, Al₂Cl₇₋, BF₄₋, PF₆₋, ClO₄₋, NO₃₋, CH₃COO, CF₃COO, CH₃SO₃₋, CF₃SO₃, (CF3SO2)2N, (CF₃SO₂)₃C⁻, AsF6−, SbF₆₋, NbF₆₋, TaF₆₋, (HF)ₙ₋, (CN)₂N⁻, C₄F₉SO₃₋, (C₂F₅SO₂)₂N, C₃F₇COO⁻, (CF₃SO₂)(CF₃CO)N⁻, and the like.

The ionic liquid may be appropriately selected from among combinations of the cation components and the anion components described above, and specific examples thereof may include, but are not limited to, 1-butylpyridinium tetrafluoroborate, 1-butylpyridinium hexafluorophosphate, 1-butyl-3-methylpyridinium tetrafluoroborate, 1-butyl-3-methylpyridinium trifluoromethanesulfonate, 1-butyl-3-methylpyridinium bis(trifluoromethanesulfonyl)imide, 1-butyl-3-methylpyridinium bis(pentafluoroethanesulfonyl)imide, 1-hexylpyridinium tetrafluoroborate, 2-methyl-1-pyrroline tetrafluoroborate, 1-ethyl-2-phenylindole tetrafluoroborate, 1,2-dimethylindole tetrafluoroborate, 1-ethylcarbazole tetrafluoroborate, 1-ethyl-3-methylimidazolium tetrafluoroborate, 1-ethyl-3-methylimida 7olium acetate, 1-ethyl-3-methylimidazolium trifluoroacetate, 1-ethyl-3-methylimidazolium heptafluorobutyrate, 1-ethyl-3-methylimidazolium trifluoromethanesulfonate, 1-ethyl-3-methylimidazolium pentafluorobutanesulfonate, 1-ethyl-3-methylimidazolium dicyanamide, 1-ethyl-3-methylimidazolium bis(trifluoromethanesulfonyl)imide, 1-ethyl-3-methylimidazolium bis(pentafluoroethanesulfonyl)imide, 1-ethyl-3-methylimidazolium tris(trifluoromethanesulfonyl) methide, 1-butyl-3-methylimidazolium tetrafluoroborate, 1-butyl-3-methylimidazolium hexafluorophosphate, 1-butyl-3-methylimidazolium trifluoroacetate, 1-butyl-3-methylimidazolium heptafluorobutyrate, 1-butyl-3-methylimidazolium trifluoromethanesulfonate, 1-butyl-3-methylimidazolium perfluorobutanesulfonate, 1-butyl-3-methylimidazolium bis(trifluoromethanesulfonyl)imide, 1-hexyl-3-methylimidazolium bromide, 1-hexyl-3-methylimidazolium chloride, 1-hexyl-3-methylimidazolium tetrafluoroborate, 1-hexyl-3-methylimidazolium hexafluorophosphate, 1-hexyl-3-methylimidazolium trifluoromethanesulfonate, 1-octyl-3-methylimidazolium tetrafluoroborate, 1-octyl-3-methylimidazolium hexafluorophosphate, 1-hexyl-2,3-dimethylimidazolium tetrafluoroborate, 1,2-dimethyl-3-propylimidazolium bis(trifluoromethanesulfonyl)imide, 1-methylpyrazolium tetrafluoroborate, 3-methylpyrazolium tetrafluoroborate, tetrahexylammonium bis(trifluoromethanesulfonyl)imide, diallyldimethylammonium tetrafluoroborate, diallyldimethylammonium trifluoromethanesulfonate, diallyldimethylammonium bis(trifluoromethanesulfonyl)imide, diallyldimethylammonium bis(pentafluoroethanesulfonyl)imide, N,N-diethyl-N-methyl-N-(2-methoxyethyl)ammonium tetrafluoroborate, N,N-diethyl-N-methyl-N-(2-methoxyethyl)ammonium trifluoromethanesulfonate, N,N-diethyl-N-methyl-N-(2-methoxyethyl)ammonium bis(trifluoromethanesulfonyl)imide, N,N-diethyl-N-methyl-N-(2-methoxyethyl)ammonium bis(pentafluoroethanesulfonyl)imide, glycidyltrimethylammonium trifluoromethanesulfonate, glycidyltrimethylammonium bis(trifluoromethanesulfonyl)imide, glycidyltrimethylammonium bis(pentafluoroethanesulfonyl)imide, 1-butylpyridinium (trifluoromethanesulfonyl)trifluoroacetamide, 1-butyl-3-methylpyridinium (trifluoromethanesulfonyl)trifluoroacetamide, 1-ethyl-3-methylimidazolium (trifluoromethanesulfonyl)trifluoroacetamide, N,N-diethyl-N-methyl-N-(2-methoxyethyl)ammonium (trifluoromethanesulfonyl)trifluoroacetamide, diallyldimethylammonium (trifluoromethanesulfonyl)trifluoroacetamide, glycidyltrimethylammonium (trifluoromethanesulfonyl)trifluoroacetamide, N,N-dimethyl-N-ethyl-N-propylammonium bis(trifluoromethanesulfonyl)imide, N,N-dimethyl-N-ethyl-N-butylammonium bis(trifluoromethanesulfonyl)imide, N,N-dimethyl-N-ethyl-N-pentylammonium bis(trifluoromethanesulfonyl)imide, N,N-dimethyl-N-ethyl-N-hexylammonium bis(trifluoromethanesulfonyl)imide, N,N-dimethyl-N-ethyl-N-heptylammonium bis(trifluoromethanesulfonyl)imide, N,N-dimethyl-N-ethyl-N-nonylammonium bis(trifluoromethanesulfonyl)imide, N,N-dimethyl-N,N-dipropylammonium bis(trifluoromethanesulfonyl)imide, N,N-dimethyl-N-propyl-N-butylammonium bis(trifluoromethanesulfonyl)imide, N,N-dimethyl-N-propyl-N-pentylammonium bis(trifluoromethanesulfonyl)imide, N,N-dimethyl-N-propyl-N-hexylammonium bis(trifluoromethanesulfonyl)imide, N,N-dimethyl-N-propyl-N-heptylammonium bis(trifluoromethanesulfonyl)imide, N,N-dimethyl-N-butyl-N-hexylammonium bis(trifluoromethanesulfonyl)imide, N,N-dimethyl-N-butyl-N-heptylammonium bis(trifluoromethanesulfonyl)imide, N,N-dimethyl-N-pentyl-N-hexylammonium bis(trifluoromethanesulfonyl)imide, N,N-dimethyl-N,N-dihexylammonium bis(trifluoromethanesulfonyl)imide, trimethylheptylammonium bis(trifluoromethanesulfonyl)imide, N,N-diethyl-N-methyl-N-propylammonium bis(trifluoromethanesulfonyl)imide, N,N-diethyl-N-methyl-N-pentylammonium bis(trifluoromethanesulfonyl)imide, N,N-diethyl-N-methyl-N-heptylammonium bis(trifluoromethanesulfonyl)imide, N,N-diethyl-N-propyl-N-pentylammonium bis(trifluoromethanesulfonyl)imide, triethylpropylammonium bis(trifluoromethanesulfonyl)imide, triethylpentylammonium bis(trifluoromethanesulfonyl)imide, triethylheptylammonium bis(trifluoromethanesulfonyl)imide, N,N-dipropyl-N-methyl-N-ethylammonium bis(trifluoromethanesulfonyl)imide, N,N-dipropyl-N-methyl-N-pentylammonium bis(trifluoromethanesulfonyl)imide, N,N-dipropyl-N-butyl-N-hexylammonium bis(trifluoromethanesulfonyl)imide, N,N-dipropyl-N,N-dihexylammonium bis(trifluoromethanesulfonyl)imide, N,N-dibutyl-N-methyl-N-pentylammonium bis(trifluoromethanesulfonyl)imide, N,N-dibutyl-N-methyl-N-hexylammonium bis(trifluoromethanesulfonyl)imide, trioctylmethylammonium bis(trifluoromethanesulfonyl)imide, N-methyl-N-ethyl-N-propyl-N-pentylammonium bis(trifluoromethanesulfonyl)imide, and the like.

The lithium salt may specifically include, but is not limited to, LiBr, LiI, LiBF₄, LiPF₆, LiSCN, LiClO₄, LiCF₃SO₃, Li(CF₃SO₂)₂N, Li(C₂F₅SO₂)₂N, Li(CF₃SO₂)₃C, and the like.

The quaternary ammonium salt may be a polymer having a quaternary ammonium salt group, and the polymer may be a copolymer of a monomer having a quaternary ammonium salt group and a monomer not having a quaternary ammonium salt group. For example, the copolymer may be obtained in a manner in which a monomer containing an N,N-dialkylamino group is quaternized and then polymerized with a monomer copolymerizable therewith or in which a monomer containing an N,N-dialkylamino group and a monomer copolymerizable therewith are copolymerized to afford a copolymer, the N,N-dialkylamino group of which is then quaternized.

Examples of the monomer containing the N,N-dialkylamino group may include, but are not limited to, N,N-dimethylaminoethyl (meth)acrylate, N,N-diethylaminoethyl (meth)acrylate, N,N-dimethylaminopropyl (meth)acrylate, N,N-diethylaminopropyl (meth)acrylate, N,N-dimethylaminobutyl (meth)acrylate, N,N-diethylaminobutyl (meth)acrylate, N,N-dihydroxyethylaminoethyl (meth)acrylate, N,N-dimethyl (meth)acrylamide, N,N-diethyl (meth)acrylamide, and the like.

Examples of the monomer copolymerizable with the monomer containing the N,N-dialkylamino dialkylamino group may include, but are not limited to, (meth)acrylic acid, alkyl (meth)acrylates such as methyl (meth)acrylate, ethyl (meth)acrylate, propyl (meth)acrylate, butyl (meth)acrylate, 2-ethylhexyl (meth)acrylate, stearyl (meth)acrylate, lauryl (meth)acrylate, tridecyl (meth)acrylate, dodecyl (meth)acrylate, etc., hydroxyalkyl (meth)acrylates such as 2-hydroxyethyl (meth)acrylate, 2-hydroxypropyl (meth)acrylate, hydroxybutyl (meth)acrylate, etc., alkyl (meth)acrylates having a cyclic structure such as benzyl (meth)acrylate, cyclohexyl (meth)acrylate, isobornyl (meth)acrylate, dicyclopentenyl (meth)acrylate, dicyclopentenyloxyethyl (meth)acrylate, glycidyl (meth)acrylate, etc., alkoxyalkyl (meth)acrylates such as ethoxyethyl (meth)acrylate, butoxyethyl (meth)acrylate, etc., various (meth)acrylates such as ethyl carbitol (meth)acrylate, cyanoethyl (meth)acrylate, etc., alkyl (meth)acrylamides such as methyl (meth)acrylamide, ethyl (meth)acrylamide, propyl (meth)acrylamide, butyl (meth)acrylamide, 2-ethylhexyl (meth)acrylamide, stearyl (meth)acrylamide, lauryl (meth)acrylamide, tridecyl (meth)acrylamide, dodecyl (meth)acrylamide, etc., hydroxyalkyl (meth)acrylamides such as hydroxyethyl (meth)acrylamide, 2-hydroxyethyl (meth)acrylamide, hydroxypropyl (meth)acrylamide, 2-hydroxypropyl (meth)acrylamide, hydroxybutyl (meth)acrylamide, etc., alkyl (meth)acrylamides having a cyclic structure such as benzyl (meth)acrylamide, cyclohexyl (meth)acrylamide, isobornyl (meth)acrylamide, dicyclopentenyl (meth)acrylamide, dicyclopentenyloxyethyl (meth)acrylamide, glycidyl (meth)acrylamide, etc., alkoxyalkyl (meth)acrylamides such as ethoxyethyl (meth)acrylamide, butoxyethyl (meth)acrylamide, etc., various (meth)acrylamides such as ethyl carbitol (meth)acrylamide, cyanoethyl (meth)acrylamide, etc., styrene, methyl styrene, and the like.

In an embodiment of the present invention, the amount of the ionic antistatic agent may be 0.5 to 5 wt % based on a total of 100 wt % of the hard coating composition including the same. If the amount of the ionic antistatic agent is less than the above lower limit, antistatic performance may not be sufficiently exhibited. On the other hand, if the amount thereof exceeds the above upper limit, the mechanical strength of the hard coating layer may decrease, which may cause problems of low durability.

Photopolymerization Initiator

The photopolymerization initiator according to an aspect of the present invention contains a hydroxyethoxy group, and is used along with the aforementioned ionic antistatic agent to thus improve the mobility of ions in the hard coating layer, thereby further improving the effect of the ionic antistatic agent.

As the photopolymerization initiator, any one that is used in the art may be used without particular limitation, so long as it contains a hydroxyethoxy group as described above. In an embodiment of the present invention, the photopolymerization initiator preferably includes 2-hydroxy-1- [4(2-hydroxyethoxy)phenyl]-2-methyl-1-propanone.

Moreover, the photopolymerization initiator of the present invention may further include a photopolymerization initiator typically used in the art in addition to the initiator described above. For example, hydroxyketones, aminoketones, hydrogen-abstraction-type photoinitiators, and the like may be included, but the present invention is not limited thereto, and these initiators may be used alone or in combinations of two or more thereof.

In an embodiment of the present invention, the amount of the photopolymerization initiator may be 0.1 to 10 wt %, and preferably 0.5 to 5 wt %, based on a total of 100 wt % of the hard coating composition including the same. If the amount of the photopolymerization initiator is less than the above lower limit, the rate of curing of the hard coating composition may decrease, and thus curing may not occur, which may deteriorate mechanical properties. On the other hand, if the amount thereof exceeds the above upper limit, overcuring may occur, which may cause cracking of the coating film.

In an embodiment of the present invention, the hard coating composition may further include at least one selected from the group consisting of a light-transmissive resin, a solvent, and an additive.

Light-Transmissive Resin

The light-transmissive resin is a photocurable resin, and the photocurable resin may include a photocurable (meth)acrylate oligomer or monomer.

The photocurable (meth)acrylate oligomer may typically include epoxy (meth)acrylate, urethane (meth)acrylate, and the like, and the use of urethane (meth)acrylate is preferable, but the present invention is not limited thereto. The urethane (meth)acrylate may be prepared from a multifunctional (meth)acrylate having a hydroxyl group in the molecule and a compound having an isocyanate group in the presence of a catalyst. Specific examples of the (meth)acrylate having a hydroxyl group in the molecule may include at least one selected from the group consisting of 2-hydroxyethyl (meth)acrylate, 2-hydroxyisopropyl (meth)acrylate, 4-hydroxybutyl (meth)acrylate, caprolactone ring-opened hydroxyacrylate, pentaerythritol tri/tetra(meth)acrylate mixtures, and dipentaerythritol penta/hexa(meth)acrylate mixtures. Also, specific examples of the compound having an isocyanate group may include at least one selected from the group consisting of 1,4-diisocyanatobutane, 1,6-diisocyanatohexane, 1,8-diisocyanatooctane, 1,12-diisocyanatododecane, 1,5-diisocyanato-2-methylpentane, trimethyl-1,6-diisocyanatohexane, 1,3-bis(isocyanatomethyl)cyclohexane, trans-1,4-cyclohexene diisocyanate, 4,4′-methylenebis(cyclohexylisocyanate), isophorone diisocyanate, toluene-2,4-diisocyanate, toluene-2,6-diisocyanate, xylene-1,4-diisocyanate, tetramethylxylene-1,3-diisocyanate, 1-chloromethyl-2,4-diisocyanate, 4,4′-methylenebis(2,6-dimethylphenyl isocyanate), 4,4′ -oxybis(phenyl isocyanate), trifunctional isocyanate derived from hexamethylene diisocyanate, and trimethylene propanol adduct toluene diisocyanate.

The monomer that is used may be a typical one, and examples thereof may include those having in the molecule an unsaturated group such as a (meth)acryloyl group, a vinyl group, a styryl group, an allyl group, etc. as the photocurable functional group, and among these, a (meth)acryloyl group is preferable.

Specific examples of the monomer having a (meth)acryloyl group may include at least one selected from the group consisting of neopentyl glycol acrylate, 1,6-hexanediol (meth)acrylate, propylene glycol di(meth)acrylate, triethylene glycol di(meth)acrylate, dipropylene glycol di(meth)acrylate, polyethylene glycol di(meth)acrylate, polypropylene glycol di(meth)acrylate, trimethylolpropane tri(meth)acrylate, trimethylolethane tri(meth)acrylate, 1,2,4-cyclohexane tetra(meth)acrylate, pentaglycerol tri(meth)acrylate, pentaerythritol tetra(meth)acrylate, pentaerythritol tri(meth)acrylate, dipentaerythritol tri(meth)acrylate, dipentaerythritol penta(meth)acrylate, dipentaerythritol tetra(meth)acrylate, dipentaerythritol hexa(meth)acrylate, tripentaerythritol tri(meth)acrylate, tripentaerythritol hexa tri(meth)acrylate, bis(2-hydroxyethyl)isocyanurate di(meth)acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, tetrahydrofurfuryl (meth)acrylate, phenoxyethyl (meth)acrylate, and isoborneol (meth)acrylate.

As the light-transmissive resin listed above, the photocurable (meth)acrylate oligomer and monomer may be used alone or in combinations of two or more thereof.

The amount of the light-transmissive resin is not particularly limited in the present invention, and, for example, the amount thereof may be 1 to 80 parts by weight based on a total of 100 parts by weight of the hard coating composition. If the amount thereof is less than 1 part by weight, it is difficult to sufficiently increase strength. On the other hand, if the amount thereof exceeds 80 parts by weight, curling may occur.

Solvent

The type of solvent is not particularly limited in the present invention, and any solvent that is used in the art may be used without limitation. Specifically, the solvent may include, but is not limited to, alcohols (e.g., methanol, ethanol, isopropanol, butanol, methyl cellosolve, ethyl cellosolve, and the like), ketones (e.g., methyl ethyl ketone, methyl butyl ketone, methyl isobutyl ketone, diethyl ketone, dipropyl ketone, cyclohexanone, and the like), hexanes (hexane, heptane, octane, and the like), benzenes (benzene, toluene, xylene, and the like), etc.

The amount of the solvent may be 10 to 95 wt % based on a total of 100 wt % of the hard coating composition. If the amount of the solvent is less than the above lower limit, workability may be poor due to the high viscosity, and also the substrate layer may be incapable of sufficiently swelling. On the other hand, if the amount thereof exceeds the above upper limit, the drying process may take a lot of time and economic benefits may be negated. Hence, the amount of the solvent preferably falls within the above range.

Additive

The type of additive is not particularly limited in the present invention, and examples thereof may include inorganic oxide fine particles, leveling agents, and the like.

The inorganic oxide fine particles are uniformly formed in the coating film, and have an advantage of improving mechanical properties such as wear resistance, scratch resistance, pencil hardness and the like.

The inorganic oxide fine particles that are used may have a particle diameter of 100 nm or less. As such, agglomeration in the composition may be prevented, thus enabling the formation of a uniform coating film, thereby preventing mechanical properties from deteriorating.

Examples of the inorganic oxide fine particles may include, but are not limited to, silicon oxide (silica), titanium oxide, aluminum oxide, zinc oxide, tin oxide, zirconium oxide, and the like.

The leveling agent may include a silicone-based leveling agent, a fluorine-based leveling agent, and an acrylic leveling agent, but is not limited thereto. When the leveling agent described above is included therewith, it is possible to confer smoothness and coatability when forming a coating film.

In an embodiment of the present invention, the thickness of the hard coating layer may be 5 to 50 μm, and preferably 5 to 20 μm. If the thickness of the hard coating film is less than the above lower limit, durability such as hardness and the like may be deteriorated. On the other hand, if the thickness thereof exceeds the above upper limit, bendability may become problematic, or the formation of a thin film may become difficult.

<Window>

Another aspect of the present invention pertains to a window including the hard coating film described above formed on at least one surface thereof. The window includes the hard coating film of the present invention, and may serve to protect other elements of an image display device including the window from external impacts or changes in ambient temperature and humidity, and also, the window exhibits high transmittance and thus improved optical performance, and antistatic performance is also improved due to the low surface resistance thereof. Moreover, the window may exhibit not only superior durability such as scratch resistance and the like but also superior bending resistance and may thus be applied to a flexible image display device.

The window may be made flexible by including a transparent substrate having flexibility, rather than being rigid or stiff like conventional glass. Specifically, it may be used to replace a touch panel for displays such as LCDs, OLEDs, LEDs, FEDs, etc., various mobile communication terminals using the same, smartphones or tablet PCs, and a cover glass for electronic paper, or may be used as a functional layer.

<Image Display Device>

Still another aspect of the present invention pertains to an image display device including the window as described above. The image display device includes the window as described above, and thus exhibits high transmittance and thus improved optical performance and antistatic performance is also improved due to the low surface resistance thereof. Moreover, the image display device has not only superior durability such as scratch resistance and the like but also superior bending resistance, and is thus flexible.

Specific examples of the image display device may include a liquid crystal display (LCD), an organic FT display, a liquid crystal projector, a display device for a game machine, a display device for a portable terminal such as a mobile phone, a display device for a digital camera, a display device for a car navigation system, and the like.

The image display device may include other elements that may be typically included in an image display device, for example, a light-emitting device such as a light source, etc., a light guide plate, and a liquid crystal display unit including a color filter according to the present invention, and the present invention is not limited thereto.

A better understanding of the present invention may be obtained via the following examples. However, the examples of the present invention may be modified in various forms, and the scope of the present specification is not to be construed as being limited to the following examples. The examples of the present invention are provided to more fully explain the present specification to those having ordinary knowledge in the art to which the present invention pertains. Unless otherwise mentioned, “%” and “part”, indicating amounts in the following examples, are given on a weight basis.

### PREPARATION EXAMPLES

### Preparation of Hard Coating Composition

### Preparation Example 1

A hard coating composition was prepared by mixing 45 parts by weight of 6-functional urethane acrylate (Kyoeisha Chemical, UA-306H), 2 parts by weight of an ionic liquid (DKS, Elexcel AS-804), 50 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 2

A hard coating composition was prepared by mixing 45 parts by weight of 6-functional urethane acrylate (Kyoeisha Chemical, UA-306H), 2 parts by weight of an ionic liquid (DKS, Elexcel AS-110), 50 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 3

A hard coating composition was prepared by mixing 45 parts by weight of 6-functional urethane acrylate (Kyoeisha Chemical, UA-306H), 2 parts by weight of lithium bis(trifluoromethanesulfonyl)imide, 50 parts by weight of methyl ethyl ketone, 2.7 parts by weight of 2-hydroxy-1[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 4

A hard coating composition was prepared by mixing 45 parts by weight of 6-functional urethane acrylate (Kyoeisha Chemical, UA-306H), 2 parts by weight of lithium bis(fluorosulfonyl)imide, 50 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 5

A hard coating composition was prepared by mixing 45 parts by weight of 6-functional urethane acrylate (Kyoeisha Chemical, UA-306H), 2 parts by weight of a quaternary ammonium salt (DKS, Elexcel MP-457), 50 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 6

A hard coating composition was prepared by mixing 45 parts by weight of 6-functional urethane acrylate (Kyoeisha Chemical, UA-306H), 2 parts by weight of an ionic liquid (DKS, Elexcel AS-804), 50 parts by weight of methyl ethyl ketone, 1.4 parts by weight of 2-hydroxy-1-[4-(2-hydroxyethoxy)phenyl]-2-methyl-1-propanone, 1.3 parts by weight of 1-hydroxycyclohexyl phenyl ketone, and 0.3 parts by weight of a silicone-based additive (BYK, BYK-307) using a stirrer, followed by filtration using a filter made of a PP material.

### Preparation Example 7

A hard coating composition was prepared by mixing 41 parts by weight of 6-functional urethane acrylate (Kyoeisha Chemical, UA-306H), 4 parts by weight of an ionic liquid (DKS, Elexcel AS-804), 50 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 8

A hard coating composition was prepared by mixing 45 parts by weight of 6-functional urethane acrylate (Kyoeisha Chemical, UA-306H), 2 parts by weight of an ionic liquid (DKS, Elexcel AS-804), 50 parts by weight of methyl ethyl ketone, 2.7 parts by weight of 1-hydroxycyclohexyl phenyl ketone, and 0.3 parts by weight of a silicone-based additive (BYK, BYK-307) using a stirrer, followed by filtration using a filter made of a PP material.

### Preparation Example 9

A hard coating composition was prepared by mixing 47 parts by weight of 6-functional urethane acrylate (Kyoeisha Chemical, UA-306H), 50 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Preparation Example 10

A hard coating composition was prepared by mixing 45 parts by weight of 6-functional urethane acrylate (Kyoeisha Chemical, UA-306H), 10 parts by weight of an antimony tin oxide nanoparticle dispersion (MEK dispersion, solid content: 30%), 42 parts by weight of methyl ethyl ketone, 2.7 parts by weight of 2-hydroxy-1-[4-(2-hydroxyethoxy)phenyl]-2-methyl-1-propanone, and 0.3 parts by weight of a silicone-based additive (BYK, BYK-307) using a stirrer, followed by filtration using a filter made of a PP material.

### Examples and Comparative Examples: Preparation of Hard Coating Film

### Example 1

The hard coating composition of Preparation Example 1 was applied on a substrate film (a polyimide film, 50 μm) such that the thickness thereof after curing was 10 μm, after which the solvent was dried, followed by irradiation with UV light at a cumulative dose of 400 mJ/cm² in a nitrogen atmosphere, thereby manufacturing a hard coating film.

### Example 2

A hard coating film was manufactured in the same manner under the same conditions as in Example 1, with the exception that the composition of Preparation Example 2 was used in lieu of the hard coating composition of Preparation Example 1 used in Example 1.

### Example 3

A hard coating film was manufactured in the same manner under the same conditions as in Example 1, with the exception that the composition of Preparation Example 3 was used in lieu of the hard coating composition of Preparation Example 1 used in Example 1.

### Example 4

A hard coating film was manufactured in the same manner under the same conditions as in Example 1, with the exception that the composition of Preparation Example 4 was used in lieu of the hard coating composition of Preparation Example 1 used in Example 1.

### Example 5

A hard coating film was manufactured in the same manner under the same conditions as in Example 1, with the exception that the composition of Preparation Example 5 was used in lieu of the hard coating composition of Preparation Example 1 used in Example 1.

### Example 6

A hard coating film was manufactured in the same manner under the same conditions as in Example 1, with the exception that the composition of Preparation Example 6 was used in lieu of the hard coating composition of Preparation Example 1 used in Example 1.

### Example 7

A hard coating film was manufactured in the same manner under the same conditions as in Example 1, with the exception that the composition of Preparation Example 7 was used in lieu of the hard coating composition of Preparation Example 1 used in Example 1.

### Comparative Example 1

A hard coating film was manufactured in the same manner under the same conditions as in Example 1, with the exception that the composition of Preparation Example 8 was used in lieu of the hard coating composition of Preparation Example 1 used in Example 1.

### Comparative Example 2

A hard coating film was manufactured in the same manner under the same conditions as in Example 1, with the exception that the composition of Preparation Example 9 was used in lieu of the hard coating composition of Preparation Example 1 used in Example 1.

### Comparative Example 3

A hard coating film was manufactured in the same manner under the same conditions as in Example 1, with the exception that the composition of Preparation Example 10 was used in lieu of the hard coating composition of Preparation Example 1 used in Example 1.

### Test Example 1

### Evaluation of Scratch Resistance

In the hard coating film manufactured in each of Examples and Comparative Examples, a substrate film was attached to glass using a transparent pressure-sensitive adhesive such that the surface of the hard coating layer (cured surface of the hard coating composition) was oriented upwards, after which reciprocating friction was applied thereto 10 times under a load of 500 g/cm² using steel wool (#0000), and scratches in the portion subjected to friction were observed with the naked eye through transmission and reflection using a triple-wavelength lamp, and the number of scratches was observed. The evaluation criteria were as follows, and the results thereof are shown in Table 1 below.

<Evaluation Criteria>

0: 0 to 10 scratches are visible

x 11 or more scratches are visible

### Test Example 2

### Measurement of Transmittance

The transmittance of the hard coating film manufactured in each of Examples and Comparative Examples was measured using an integrating sphere spectrophotometer CM-3600D. The results thereof are shown in Table 1 below.

### Test Example 3

### Measurement of Surface Resistance

In the hard coating film manufactured in each of Examples and Comparative Examples, the surface of the hard coating layer (cured surface of the hard coating composition) was measured for surface resistance by applying a voltage of 500 V thereto using a Mitsubishi surface resistance meter. The results thereof are shown in Table 1 below.

### Test Example 4

### Evaluation of Bending Resistance

The hard coating film manufactured in each of Examples and Comparative Examples was tested by being repeatedly folded and unfolded 200,000 times with a radius of curvature of 1 mm such that the surface of the hard coating layer (cured surface of the hard coating composition) was folded inwards, and whether the film broke was observed. The evaluation criteria were as follows, and the results thereof are shown in Table 1 below.

<Evaluation Criteria>

o: No breakage

x: Breakage

TABLE 1

| | Hard | Scratch | Trans- | Surface | |
|---|---|---|---|---|---|
| | coating | resis- | mittance | resistance | Bending |
| | composition | tance | (%) | (Ω/□) | resistance |
| Example 1 | Preparation | ∘ | 90.5 | 1E+11 | ∘ |
| | Example 1 | | | | |
| Example 2 | Preparation | ∘ | 90.4 | 4E+11 | ∘ |
| | Example 2 | | | | |
| Example 3 | Preparation | ∘ | 90.2 | 6E+10 | ∘ |
| | Example 3 | | | | |
| Example 4 | Preparation | ∘ | 90.4 | 8E+10 | ∘ |
| | Example 4 | | | | |
| Example 5 | Preparation | ∘ | 90.5 | 5E+11 | ∘ |
| | Example 5 | | | | |
| Example 6 | Preparation | ∘ | 90.4 | 2E+11 | ∘ |
| | Example 6 | | | | |
| Example 7 | Preparation | ∘ | 89.7 | 3E+10 | ∘ |
| | Example 7 | | | | |
| Comparative | Preparation | ∘ | 90.3 | 3E+12 | ∘ |
| Example 1 | Example 8 | | | | |
| Comparative | Preparation | ∘ | 90.4 | OVER | ∘ |
| Example 2 | Example 9 | | | 9E+14 | |
| Comparative | Preparation | ∘ | 88.7 | 3E+11 | ∘ |
| Example 3 | Example 10 | | | | |

As is apparent from Table 1, in Examples 1 to 7 satisfying all of the composition requirements of the present invention, scratch resistance and bending resistance were superior, optical performance was superior due to the transmittance of 89.0% or more, and antistatic performance was also superior due to the low surface resistance. In contrast, in Comparative Example 1 not including the photopolymerization initiator containing a hydroxyethoxy group and Comparative Example 2 not including the ionic antistatic agent, antistatic performance was inferior. In Comparative Example 3 including an antistatic agent other than the ionic antistatic agent, the transmittance was lower.

1. A hard coating film, configured such that a hard coating layer comprising a cured product of a hard coating composition is formed on at least one surface of a substrate,
wherein the hard coating composition comprises an ionic antistatic agent and a photopolymerization initiator containing a hydroxyethoxy group,
a surface resistance of the hard coating layer is 1E+9 to 1E+12 Ω/□, and a total transmittance thereof is 89.0% or more.

2. The hard coating film of claim 1, wherein the hard coating composition further comprises at least one selected from the group consisting of a light-transmissive resin, a solvent, and an additive.

3. The hard coating film of claim 1, wherein the photopolymerization initiator comprises 2-hydroxy-1-[4-(2-hydroxyethoxy)phenyl]-2-methyl-l-propanone.

4. The hard coating film of claim 1, wherein an amount of the ionic antistatic agent is 0.5 to 5 wt % based on a total of 100 wt % of the hard coating composition comprising the same.

5. The hard coating film of claim 1, wherein an amount of the photopolymerization initiator is 0.1 to 10 wt % based on a total of 100 wt % of the hard coating composition comprising the same.

6. The hard coating film of claim 1, wherein the substrate comprises a polyimide-based resin.

7. A window comprising the hard coating film of claim 1.

8. An image display device comprising the window of claim 7.

9. The image display device of claim 8, wherein the image display device is a flexible image display device.
